(19) United States
(12) Patent Application Publication
(10) Pub. No.: US 2014/0278212 A1
(43) Pub. Date: Sep. 18, 2014

(54) LOCATION-BASED TRACKING SYSTEM

(71) Applicant: TELMATE LLC, San Francisco, CA (US)

(72) Inventors: Richard Torgersrud, San Francisco, CA (US); Christopher Ditto, San Jose, CA (US)

(73) Assignee: Telmate LLC, San Francisco, CA (US)

(21) Appl. No.: 13/842,437

(22) Filed: Mar. 15, 2013

(51) Int. Cl. G01B 21/16

(52) U.S. Cl. CPC G01B 21/16
USPC 702/150

(57) ABSTRACT

Geoposition data is gathered from financial transactions, digital communications, or digital files that have been exchanged between individuals, within a detention facility and individuals who are not subject to a detention environment. The geoposition data is visually represented allowing the geographical relationships between outside parties and individuals within detention facilities to be seen. A system and method of visually representing relationships, such as transactions, communications, associations or other commonalities, between individuals in detention environments (such as prisons or detention facilities) with one or more individuals within or external to such detention environments.

This disclosure relates to a system for gathering, storing, tracking and/or visually representing geoposition data for one or more persons who interact with one or more individuals subject to a detention environment. The latter individuals may reside in or be secured in, or on parole, work release or probation from a jail, prison, detention facility, secured hospital or addiction treatment facility. This disclosure also relates to a system for gathering, tracking and/or storing geographical data for interactions between (1) individuals in a detention environment and (2) parties and/or devices outside the detention environment. The system may be used to aggregate, visualize, investigate and/or exploit the geographical data and other data.

### BACKGROUND

Known detention environments, such as jails, prisons, detention facilities, secured hospitals, and addiction treatment facilities, have no automated system or mechanism that an investigator can use to visualize the geographical interactions and connections between individuals within the detention environment and the outside parties and devices with whom they interact.

Although it is known to use telephone records to ascertain the geographical location of an outside party interacting with someone inside a detention environment, any visualization of such data would have to be done by hand. An investigator can look up the physical address of the owner of a phone number and physically draw the location on a map, or manually create a computer file containing the relevant information; however, the known method is tedious, time-consuming, and subject to error. There is a need for a system that can provide an investigator with the ability to obtain and visualize data that otherwise would be inaccessible, and that improves and streamlines the investigative process, and enables investigators to research and identify possible connections between and among inmates and those persons outside the facility these inmates communicate with, so as to solve and prevent crimes.

### SUMMARY

The problems and disadvantages of the prior art are overcome to a great extent by a location-based tracking system that has a data extracting device, a server, and a display generating device, among other things. The first device extracts position data and other data from transactions involving at least two parties, two devices, or at least one party and one device, where a first one of the parties/devices is located in a secured facility and a second one of the parties/devices is located outside of the secured facility, and where the position data represent geographical locations of the respective parties/devices. The server stores the position data in a non-transitory machine-readable medium in association with the respective transactions and the respective parties/devices. The display-generating device then receives information from the machine-readable medium, for example, under the control of a processor, and displays connections between the parties/devices, and the locations of outside parties/devices, in association with the respective transactions and the respective geographical locations.

This disclosure also relates to an investigation system that has a server, a display-generating device, and a user interface. In operation, the server stores position data in association with respective transactions and respective parties, where the transactions involve at least two parties (or two devices), a first one of the parties (or the first device) is located in a detention environment, which may include a secured facility, and a second one of the parties (or the second device) is located outside of the detention environment, and the position data represent geographical locations of the second party and the second device during the transactions. The second device displays connections between the parties/devices in association with the respective transactions and the respective geographical locations. The user interface, which may be a graphical user interface for an electronic device, may be used to receive query information from an investigator, input the query to a processor of the electronic device, and cause the display generating device to generate a display that is responsive to the query information.

Some geoposition data may be established automatically by taking a photograph. According to one aspect of the disclosure, the data may be obtained for use by an investigator when the photograph is posted to another system or device, even when there is no direct communication between someone inside the detention environment and someone else. According to one aspect of this disclosure, the photograph location data may be relevant to the investigator even though the location where the photograph was taken is not particularly relevant to any person involved in posting or communicating about the photograph. The data may be relevant to the investigator because it links a third person to the geographic location.

This disclosure also relates to a method of rendering personal information about a first person within a detention environment who interacts with another person outside the detention environment. According to this aspect, the method includes the step of extracting position data from a transaction between the two persons, where the position data represent a geographical location of the second person. After being extracted, the position data is stored in a server in association with the respective transactions and parties. The stored information may be combined with previously extracted information of the same type and other types of data already stored in the server. Subsequently, connections between the parties are displayed, in a suitable format, in association with the respective transactions and geographical locations.

According to another aspect of this disclosure, a system is configured to detect or identify an interaction between a person in a detention environment and a person outside the detention environment. Geoposition data that can be extracted, estimated or otherwise derived from interactions is tracked and may be visually displayed for the user of the automated system.

According to another aspect of this disclosure, when a person located outside a detention environment, e.g., a detention facility, communicates or interacts with a person inside the detention environment, the first person's geoposition data is approximated from his/her network protocol and stored on a data storage device. If the first person transmits a digital image or a video file to the second person, geoposition data is extracted from that file and stored on a data storage device. Subsequently, a user (e.g., a law enforcement investigator) can query and visualize any and all gathered and stored data.

### BRIEF DESCRIPTION OF DRAWINGS

FIG. 1 is a schematic diagram of a preferred embodiment constructed in accordance with this disclosure; and

FIG. 2 is a process flow chart for the preferred embodiment of FIG. 1.

### DETAILED DESCRIPTION

This disclosure relates to, though is not limited to, a system and a process for automatically gathering, tracking, and storing geographical data for interactions between individuals in a detention environment and outside parties, enabling users to aggregate and visualize the accumulated data. An investigator may use the system, for example, to track location patterns in interactions between a prison inmate and someone else (e.g., a family member or friend of the inmate) located outside of the detention environment.

If an individual inside a detention environment interacts with one or more outside parties believed to be involved in criminal gang activity, or with individuals who may otherwise provide clues to criminal activity or other forms of intelligence, and who may overtly or inadvertently expose previously undetected links between and among inmates and other persons, an investigator can visualize geoposition data pertaining to the location of the outside party during telephone calls, video visitation, text messaging, or other transactions. By visualizing geoposition data for all interactions between the individual inside the secured facility and the outside parties, investigators may ascertain where suspected gang associates of the individual in the secured facility reside and/or congregate.

The phrase “detention environment,” as used herein, may be a jail, prison, detention facility, secured facility, secured hospital, addiction treatment facility, or any other environment in which an individual is being detained. Individuals who are not subject to a detention environment, but who interact with those in a detention environment, include, but are not limited to, friends, family members, counselors, attorneys, religious personnel, and medical personnel.

The interactions entered into by those in a detention environment may include one or more financial transactions, such as the payment of bail, depositing of money using a Web browser or other software application, and payment over the phone or from a kiosk. The interactions may also include the digital exchange of information, such as digital images, texts such as emails or short message service (SMS), enhanced messaging service (EMS), or multimedia messaging service (MMS) messages, video recordings, and audio recordings such as a voicemail. Moreover, the interactions may include live communications, such as video chats, audio communications, text chats, and interactions common to electronic social networks, such as liking, friending, blocking, commenting, tagging, sharing, and so on. In addition, the interactions of interest may include unsuccessful attempts at communication, such as a financial transaction that is rejected, or an attempt to video chat in which one party does not participate, or the execution of a software application that is intended for interacting with inmates.

The phrase “geoposition data,” as used herein, is data that specifically or approximately locates a point on the Earth, such as by longitude and latitude or as a visual indication, or a marked point on a map. The data may be global in scope, or it may be confined to one or more regional or local areas. Geoposition data may be extracted from digital files, such as longitude and latitude coordinates embedded within the metadata of uploaded photos taken with a camera enabled with global positioning system (GPS) technology. Geoposition data also may be derived, such as by estimating a user's location from the strength of cell towers or from IP address information of a computer used to interact with an inmate, or it may be extracted from communication protocols, such as information included with Web page requests, or custom protocols such as from an application designed for communication with inmates that shares geolocation data from the electronic device on which it is installed. Geoposition data also may be acquired from known locations, such as when a friend of an inmate deposits cash in a kiosk that has known geocoordinates. Geoposition data also may be estimated from information entered by the user, such as when a Web site used to communicate with an inmate asks the user to identify his or her current location by typing it or clicking on a map. Geoposition data may be obtained from transactions involving two persons. Also, geoposition data may be obtained from other sources.

Once the geoposition data are tracked and stored in a suitable storage device, the system may display the data as numbers, such as latitude or longitude, or visually, such as on a map. The visual display may be the individual positions of those involved in interactions with those in detention environments, or connections between those individuals and those in detention environments. The visual display may change over time. It may, for example, be presented as a time-lapse presentation that displays interaction points over a given period of time. The visual display may be generated in other forms as well, including, but not limited to, heat maps and histograms.

The system described herein is not limited to tracking and storing direct interactions between outside parties and individuals subject to the control of or otherwise in a secured facility or other detention environment; the system includes the use of software applications and/or hardware designed for communicating with individuals who are in a detention environment. For example, a mobile phone application that is intended to facilitate communication with someone in a detention environment may track, store and/or report geoposition information at any time while it is running, not just while it is actively transacting with a detained individual. Information may be extracted from the mobile phone application, for use by an investigator, even when the mobile phone is not being used.

The accumulated data may be stored in a data storage device, located in a server. System users, such as law enforcement investigators, can query and visualize the stored data, in either static form (printed on paper, or on a screen using a computer, tablet, cell phone, PDA, or other personal electronic device) or interactively, such as with a mapping system featuring detailed geographical information, satellite images, and street-level, 360-degree photographic views. In the case of a digitally transmitted image, the user may visualize and analyze, by plotting on a map (either static or dynamic and interactive), the geographical relationship between the individual subject to or in the secured facility and the outside party.

The illustrated system may be used to identify activities, movements and patterns of activities and movements of individuals who interact with those who are suspected or known to have broken the law or otherwise threatened the security or safety of a group. Information about where the transacting individual has physically been at a given time can be gathered and stored. More useful results may be obtained when accurate location data is collected, such as from a device that includes GPS tracking. Corrections staff, or those who work with them, may visualize, in a static, dynamic, or interactive form, geographical information on the transactions between those in a detention facility and others with whom they are connected. An investigator may use the diagram to see a connection between one person in a secure facility and an outside party or a pattern of behavior or movement.

Moreover, investigators may use the system described herein to visualize functional and dynamic patterns in inmate communications. For example, investigators may utilize geoposition data from transactions to identify the geographic boundaries of a gang territory, confirm the presence of a person at the scene of a crime, or identify the location of a suspected methamphetamine production facility. By way of example, the system may indicate that two individuals were proximately located at a certain point in time, or outside of their court-permitted jurisdiction.

The system described herein may be operated in accordance with the investigation tree technology described in U.S. patent application Ser. No. 13/469,632, filed May 11, 2012. The entire disclosure of said application Ser. No. 13/469,632 is incorporated herein by reference. The investigation tree technology can provide a powerful tool for investigators to visualize connections between outside parties and individuals within secured facilities.

Turning now to the drawings, where like reference numerals designate like elements, there is shown in FIG. 1 a location-based tracking system 8 constructed in accordance with a preferred embodiment of this disclosure. In operation, an outside person 10 communicates with a detained person 12. The latter person is located in and confined in a secured facility 14 (that is, within a detention environment). The geographical location of the secured facility 14 is known. The other person 10 is located somewhere outside the secured facility 14. At the start of the process, the location of the outside person 10 is unknown. The information 16 that is transmitted from the outside person 10 to the detained person 12 may contain digital image, video, or documentary information. This disclosure is not so limited, however; the transmitted information 16 may represent other information as discussed elsewhere in this disclosure.

In operation, a data extracting device 20 extracts position data and other data from the transmitted information 16. The extracted position data represents the geographical location of the outside party (or a device located outside the detention environment) 10. The other extracted data represents information concerning the identities of the two persons (or devices) 10, 12 and the nature of the transaction, such as the type of information communicated and the time and date of the communication.

The extracted data is stored in a server 30, preferably in a non-transitory machine-readable medium 32, preferably in tables that associate the position data with the respective transaction, and the respective parties/devices 10, 12, and other relevant information. The information stored in the server 30 may be accessed by an investigator (not shown) who operates a graphical user interface (GUI) 34 connected to a processor 36. The investigator can input a query into the GUI 34 and cause a display generating device 38 to display a presentation that shows connections between the parties/devices 10, 12 in association with the respective transactions and the respective geographical locations.

This disclosure may be implemented in an investigative tool and more specifically to a system 8 and method (FIGS. 1 and 2) for visualizing and navigating dynamic relationships, including geoposition information, relating to individuals in a secure environment, and the people outside the detention environment who contact them. The system 8 illustrated in FIG. 1 has a plurality of data gathering systems 20, 100, 102, 104. In the illustrated embodiment, the systems 20, 100, 102, 104 are all functionally contained within a common data-collection subsystem 106. The systems 20, 100, 102, 104 gather information relating to individuals subject to or confined within the detention environment 14; the server 30 that receives and processes dynamic information from the data gathering systems 106 and stores the information in the machine-readable medium 32; and the controller 36 that submits queries to the database in the storage device 32, in response to prompts from the GUI 34, and dynamically constructs relationships of an individual of interest from the database in order to construct a presentation (not shown) that is displayable on (or printed by) the display device 38.

Although the system 8 illustrated in FIG. 1 is located entirely within the detention environment 14, a like system may be used to monitor events and occurrences from outside the detention environment 14. In operation, the server 30 gathers information from the data gathering systems 20, 100, 102, 104. In particular, in addition to the extracting device 20, the data gathering subsystem 106 may include an identity verification system 100, a communication monitoring system 102, and other database-storing devices 104 found in or used with a detention environment network. The data gathering subsystem 106 may collect information about communications, transactions, and associations relating to an individual in the detention environment 14.

The illustrated system 8 is preferably compatible with a data gathering system such as, e.g., the interactive audio/video system and device for use in a detention environment disclosed in U.S. patent application Ser. No. 13/088,883, which is incorporated herein by reference. The system 8 is also preferably compatible with a data gathering system such as the consolidated voicemail platform disclosed in U.S. patent application Ser. No. 12/826,168, which is incorporated herein by reference. The system 8 is also preferably compatible with an information exchange facilitating system such as, e.g., the secure social network disclosed in U.S. patent application Ser. No. 13/438,940, which is incorporated herein by reference. It should be appreciated that where a definition or use of a term in an incorporated application or reference is inconsistent with or contrary to the definition of the term provided herein, the definition of the term provided herein applies.

FIG. 2 is an operational flowchart for the system 8 that is illustrated in FIG. 1. The process may be implemented in suitable software modules and/or hardware devices, under the control of the server controller 36. At the start, a determination is made as to whether a transaction 16 is occurring (S210) relevant to one or more monitored persons 12 within the detention environment 14. If a transaction 16 is not occurring (S212), the process returns to start and continues to make transaction occurrence determinations (S210). If a transaction 16 is occurring, then data is extracted from the transaction 16 by the extracting device 20 (S214). The extracted data contains geoposition data for the outside person 10 and other data associated with the transaction 16 as discussed above.

Next, the extracted data is stored in the storage device 32, where it is added to (and compiled with) other data previously gathered by the data collecting subsystem 106, and the different types of data are associated with each other in tables, all under the control of the processor 36 (S216).

Next, a determination is made as to whether a query has been input to the GUI 34, for example, by an investigator (S218). If there is no query from the GUI 34 awaiting action (S220), the process returns to make a determination as to whether a transaction 16 is occurring (S210). On the other hand, if there is a query awaiting action, a graphical presentation, which may include a map, is generated by the controller 36, using the data stored in the storage device 32, to show geoposition information about the outside person/device 10 and other information responsive to the query (S222).

Next, the presentation is displayed in one or more of the display modes described above (S224). The presentation may be studied by the investigator to gain answers to the question that caused him or her to make the query. If desired, the presentation may be printed by the display device 38 and/or saved in the storage device 32 for future reference.

Next, a determination is made as to whether there is another query awaiting action (S226). If there is no second or subsequent query awaiting action (S228), the process returns to make a determination as to whether a transaction 16 is occurring (S210). On the other hand, if there is a second or subsequent query awaiting action (S230), then another graphical presentation, which may include a map, is generated by the controller 36, using the data stored in the storage device 32, to show geoposition information about the outside person/device 10 and other information responsive to the second or subsequent query (S222). The second or subsequent query may be a refined version of the original query (e.g., using an additional filter) made by the investigator after reviewing the first presentation. Alternatively, the second or subsequent query may be the same query as the first query (stored in the storage device 32), but applied at a later time so as to consider additional information gathered from intervening transactions (S214). Alternatively, the second or subsequent query may be a different query directed to different persons/devices 10, 12 and other considerations.

This disclosure should not be limited to the process illustrated in FIG. 2. In one embodiment, the data gathering systems 106 may send information to be stored in the database of the storage device 32 whenever new information is gathered. In another embodiment, the storage device 32 may pull data from the data gathering system 106 periodically and/or upon command. In another embodiment, the storage device 32 may notify the controller 36 whenever its database receives new information so that the controller 36 can generate its own query and update a previously generated presentation with newly acquired geoposition data and/or new relationships. In addition, or alternatively, the controller 36 may implement a process that issues a warning about an individual based on predefined criteria, such as e.g., someone's presence at a predetermined geographical location of interest, suspiciously large or frequent monetary deposits, or an unusually large number of relationships to any individual.

The display device 38 (FIG. 1) may show the best known locations of people 10 who interacted with a single inmate 12, including those who received phone calls from the inmate, left voicemails for the inmate, or deposited money for the inmate. The presentation shown or printed by the display device 38 may be zoomed out, e.g., from a first presentation that shows geographical information for a single state (e.g., California) to a second display that shows locations in Canada and across the United States. If desired, the display device 38 may show a list of interactions with an inmate 12 (e.g., in a table at the bottom of the display), along with latitude and longitude, where geoposition data is available. Suitable legends may be provided so that investigators and other users can identify locations of interest from the presentation. The display device 38 may be configured to be filtered by one or more of the following: identity or location of the second one of the communication devices and/or parties, the frequency or type of transaction, chronology, and identity of the first one of the parties.

If desired, the display device 38 may be configured to display areas of heavy communication traffic (or regional blackouts) for purposes of network health analysis, monitoring and maintenance. The system may be configured, for example, to identify areas of network problems, such that the system may reroute traffic for improved performance or for further analysis.

In accordance with the practices of persons skilled in the art of computer programming, embodiments are described herein with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits. Embodiments may also encompass integrated circuitry including circuit elements capable of performing specific system operations.

When implemented in software, the elements of the embodiments are essentially the code segments to perform the necessary tasks. The non-transitory code segments may be stored in a processor-readable medium or computer-readable medium, which may include any medium that can store or transfer information. Examples of such media include an electronic circuit, a semiconductor memory device, a read-only memory (ROM), a flash memory or other non-volatile memory, a floppy diskette, a CD-ROM, an optical disk, a hard disk, a fiber optic medium, etc. User input may include any combination of a keyboard, mouse, touch screen, voice command input, etc. User input may similarly be used to direct a browser application executing on a user's computing device to one or more network resources, such as web pages, from which computing resources may be accessed.

As used herein, an individual is a person, a representation of an anonymous or unknown person, or other evidence supporting identity, such as e.g., a phone number, credit card, fingerprint, photographs, social security number, government identification, visitations, financial transactions, gang affiliation, tattoos, traits and utility bills.

As used herein, information may include communications, transactions, and associations between or mutually involving individuals. Communications may include, e.g., phone calls, voicemail, electronic messages, posts (e.g., where a prisoner posts to a website), video visits, and traditional mail. Transactions may include any financial ties or events, such as e.g., monetary deposits, buying commissary goods, creating or modifying inmate trust fund accounts, bail payments, bond payments, restitution payments, and any other payments, or interactive events, such as e.g., conducting a phone call, conducting a visit, or sending or receiving communication. Associations may include direct or indirect affiliations, or commonalities, such as e.g., shared arresting officer, shared gang affiliation, shared jail cell or pod, visitations, a linkage to a common crime or crime scene, a modus operandi, having or conducting shared or similar activity in an external network, site or group, or a family connection.

In other words, “communicating,” as used herein, refers broadly to live communications, such as video chats, audio communications, text chats, and also interactions common to electronic social networks, such as liking, friending, blocking, commenting, tagging, and sharing. A “communication” may include any tie between individuals in a controlled environment with those either inside or outside a secured environment, including, but not limited to, phone calls, voicemails, onsite visits, video visits, electronic messages and mail exchange. A “communication” may occur between an individual in a detention environment and an outside party, including land line telephone calls, cell phone calls, onsite visits, usage of a kiosk (including deposits), video visitation, text-based or video chat, VOID-based telephone calls, email, voicemail, and social networking interactions. Moreover, this disclosure may be applied to the use of a software application or device that is primarily intended for communication with a person in a detention facility, such as a mobile phone application intended for communicating with an inmate, even if a direct communication was not attempted.

As used herein, a “user” is someone using a system to query and visualize gathered data. For example, a user may be a law enforcement official tracking movement patterns of outside parties communicating with individuals inside a secured environment.

While this disclosure provides specific examples and various embodiments, it should be readily understood by those skilled in the art that many modifications and adaptations of the examples and embodiments described herein are possible without departure from the spirit and scope of the invention as claimed hereinafter. Thus, it is to be understood that this disclosure is made only by way of example and not as a limitation on the scope of the invention claimed below. What is claimed is:

1. A location-based tracking system, comprising:
a data extracting device for extracting position data from transactions involving at least two parties or devices, where a first one of the parties or devices is located in a detention environment and a second one of the parties or devices is located outside of the detention environment, and where the position data represent geographical locations associated with or identified by the second party or device;
a server for storing the position data in a non-transitory machine-readable medium in association with the respective transactions and one or more parties or devices;
a display generating device for receiving information from the non-transitory machine-readable medium and for displaying connections in association with the respective transactions and the respective geographical locations.

2. The location-based tracking system of claim 1, wherein the position data represent geographical coordinates, and wherein the extracting device is configured to extract the data from digital image or video files, digital messages, and/or physical documents.

3. The location-based tracking system of claim 1, wherein the second device includes a digital device, and the extracting device is configured to extract the position data from a digital device used by the second party to connect the second party to a first party located in the detention environment.

4. The location-based tracking system of claim 1, wherein the extracting device is configured to estimate geolocation data based on an Internet protocol, Internet service provider data, cell phone towers, cell phone tower triangulation, known Internet access points, best known address (BKA) services, and satellite data (GPS).

5. The location-based tracking system of claim 1, wherein the extracting device is configured to receive data from the second device.

6. The location-based tracking system of claim 1, wherein the position data is based on use of a predetermined access device by the second one of the parties.

7. The location-based tracking system of claim 1, wherein the data extracting device is configured to obtain information for identifying the second one of the parties.

8. A location-based investigation system, comprising:
a server for storing position data in association with respective transactions and respective parties, wherein the transactions involve at least two parties, a first one of the parties is located in a detention environment and a second one of the parties is located outside of the detention environment, and the position data represent geographical locations of one or more of the parties during the transactions;
a display generating device for displaying connections between the parties in association with the respective transactions and the respective geographical locations; and
a user interface for inputting query information and for causing the display generating device to generate a display that corresponds to the query information.

9. The location-based investigation system of claim 8, wherein the display-generating device is configured to display the connections and the geographical locations on a map.

10. The location-based investigation system of claim 9, further comprising a printer driver for transmitting map information to a printer.

11. The location-based investigation system of claim 9, further comprising a portable electronic device, and wherein the display-generating device and the user interface are located in the electronic device.

12. The location-based investigation system of claim 8, wherein the display generating device is configured to generate images of detailed geographical information together with visual representations of the respective connections.

13. The location-based investigation system of claim 8, wherein the user interface is configured to receive query information representing one or more of the following: identity or location of the second one of the parties, frequency or type of transaction, chronology, and identity of the first one of the parties.

14. The location-based investigation system of claim 8, wherein the display generating device is configured to display areas of heavy communication traffic for purposes of network health analysis, monitoring and maintenance, and is configured to be filtered by one or more of the following: identity or location of the second one of the parties, frequency or type of transaction, chronology, and identity of the first one of the parties.

15. A method of rendering personal information about a first person within a detention environment who interacts with a second person outside the detention environment, the method comprising:
extracting position data from a transaction between the first and second persons, while the first person is located in the detention environment and the second person is located outside the detention environment, wherein the position data represent a geographical location of the second person;
storing the position data in association with respective transactions and parties;
displaying connections between parties in association with respective transactions and respective geographical locations.

16. The information-rendering method of claim 15, wherein the position data is extracted from information generated by an electronic, location-enabled device.

17. The information-rendering method of claim 16, wherein a location detection device is used to extract or generate the position data.
